(19) United States
(12) Patent Application Publication
(10) Pub. No.: US 2015/0072266 A1
(43) Pub. Date: Mar. 12, 2015

(54) FUEL CELL FLUID DISTRIBUTION

(71) Applicant: INTELLIGENT ENERGY LIMITED, Loughborough, Leicestershire (GB)

(72) Inventor: Peter David Hood, Loughborough (GB)

(21) Appl. No.: 14/386,509

(22) PCT Filed: Mar. 14, 2013
(86) PCT No.: PCT/GB2013/050634

§ 371 Date: Sep. 19, 2014

(30) Foreign Application Priority Data
Mar. 19, 2012 (GB) 1204741.1

(51) Int. Cl. H01M 8/02; H01M 4/88

(52) U.S. Cl. CPC H01M 8/0258; H01M 4/8875; H01M 2300/0082
USPC 429/485; 429/535; 72/199

(57) ABSTRACT

The invention relates to methods and apparatus for forming fluid distribution channels in fuel cell electrode plates, and to plates produced by such methods. Exemplary embodiments disclosed include a method of forming fluid distribution channels in a fuel cell electrode plate (100), the method comprising traversing the plate between opposing surfaces of a roller (801) and a planar die (802) while applying pressure across the thickness of the plate to thereby form a series of channels across a surface of the plate.

The invention relates to methods and apparatus for forming fluid distribution channels in fuel cell electrode plates, and to plates produced by such methods.

Polymer electrolyte membrane (PEM) based fuel cells require as a minimum a supply of two fluid feeds, containing fuel gas (typically hydrogen) and oxidant (typically air). Cooling is normally also required, which may be provided through the oxidant feed, i.e. across the cathode of the fuel cell, or via a dedicated coolant feed. A separate coolant feed may be provided in the form of a series of separate channels isolated from the oxidant and fuel channels but arranged to extract heat from each individual fuel cell making up a fuel cell stack. An alternative cooling arrangement is to provide additional water in a controlled way through the cathode side of each fuel cell. Such additional water can function to extract heat, most efficiently by evaporating within the fuel cell and exiting as vapour. To maximise the efficiency of operation it is important to introduce a controlled amount of water in a precisely defined way across the width of each fuel cell. As each fuel cell may be of the order of 1 mm or less in thickness and several centimetres in width, achieving a desired level of control can be difficult.

One way of achieving a degree of control over the distribution of coolant is with the use of an additional shim component positioned along an edge of a fuel cell plate, the shim having etched features such as channels to direct fluids. Such shims, and the etching processes used to generate fine features, add complexity and expense to the manufacturing process. A more cost effective solution is therefore required.

An alternative way of achieving a controlled degree of water cooling within a fuel cell is disclosed in WO 2007/129030, in which a folded edge of a fuel cell plate is used to introduce a controlled amount of cooling water to a cathode side of a fluid flow feed plate. A plurality of channels is provided within the fold by means of a surface texture applied to one or both inside faces of the folded region. Coolant water is forced through the folded region and exits into cathode channels extending across the plate.

A problem with providing such a mechanism for cooling is in achieving a controlled degree of flow across the plate, together with ensuring that the distribution of coolant across the width of the plate is uniform. Furthermore, conventional methods of forming coolant channels in the plate are generally inadequate to provide the degree of fine control and small tolerances required for a uniform coolant flow rate.

It is an object of the invention to address one or more of the above mentioned problems.

In accordance with a first aspect of the invention there is provided a method of forming fluid distribution channels in a fuel cell electrode plate, the method comprising traversing the plate between opposing surfaces of a roller and a planar die while applying pressure through the thickness of the plate to thereby form a series of channels across a surface of the plate.

The invention addresses the problem of how to provide a controlled degree of coolant flow by using a combination of a roller with a planar die to form the required coolant channels. The method allows for a fine degree of control over the channel dimensions, thereby ensuring a more uniform flow of coolant across the width of the fuel cell plate in use.

In preferred embodiments the surface of the planar die comprises a series of ridges configured to form the series of channels. The surface of the roller is preferably smooth and uniform, such that the ridge shapes on the planar die are accurately transferred to corresponding channels in the plate when passed between the roller and die.

The plate may be traversed between the roller and die by fixing the plate in position relative to the die and traversing the roller across the plate while applying a pressure across the plate. Alternatively, the plate and die may be traversed across a fixed roller. In each case, a controlled force is applied between the roller and the die, for example by means of a spring-loading mechanism, or by pneumatic or hydraulic means.

The series of channels formed in the surface of the plate preferably have cross-sectional dimensions of 25 μm or smaller, and in preferred embodiments the series of channels have a depth or width in the range of 15 μm to 20 μm. A variation in the depth or width of the series of channels is preferably within ±5%, and more preferably within ±5%, of a mean value.

An angle between a rotation axis of the roller and a direction the plate is traversed between the roller and die may be 90° or, in preferred embodiments, may be less than 90°, for example less than 85° or less then 80°, and optionally between 70° and 85°. Angling the rotation axis relative to the direction of movement of the plate allows the channels to be formed progressively in a direction orthogonal to the direction of movement, thereby providing greater uniformity.

An angle between a direction of the ridges and a direction the plate is traversed between the roller and die may be 90° or, in preferred embodiments, may be less than 90°, for example less than 85° or less then 80°, and optionally between 70° and 85°. Angling the direction of the ridges, and therefore the channels, relative to the direction of movement of the plate also allows the channels to be formed progressively in a direction orthogonal to the direction of movement, thereby providing greater uniformity.

In embodiments where the angle of the rotation axis is less than 90° the surface of the roller is preferably tapered. This prevents sliding of the roller surface relative to the plate as the plate is passed between the roller and die. A taper angle on the roller surface is preferably equal to 90° less the angle between the rotation axis and the direction of movement.

The series of channels may comprise a parallel array of channels across the surface of the plate. The direction of channels may be orthogonal to the relative direction of movement between the plate and roller.

In accordance with a second aspect of the invention there is provided an apparatus for forming fluid distribution channels in a fuel cell electrode plate, the apparatus comprising a roller and a planar die configured and arranged to form a series of channels in a plate traversed between surfaces of the roller and die under pressure.

In preferred embodiments the surface of the planar die comprises a series of ridges configured to form the series of channels in the plate. In alternative embodiments the series of ridges may be provided on the surface of the roller instead.

The series of ridges may be configured to form the series of channels having cross-sectional dimensions of 25 μm or smaller. The ridges may be configured to form the series of channels with a depth or width in the range of 15 μm to 20 μm. The series of ridges optionally comprise an array of parallel ridges across the surface of the planar die.

In accordance with a third aspect of the invention there is provided a fuel cell electrode plate comprising first and second arrays of channels formed in a surface thereof within a folded region of the plate, the first array of channels extending from an edge of the plate across a first internal face of the folded region, the second array of channels extending across a second opposing face of the folded region in a second direction transverse to the first direction.

An advantage of the above configuration of first and second arrays of channels is that coolant fluid can be transported along the second array of channels across the plate, while the first array of channels distributes coolant along the edge of the folded plate. The cross-sectional dimensions of the channels in the second array are preferably greater than those in the first array, preferably by a factor of 2 or more.

The folded region may further comprise a port through the thickness of the plate in fluid communication with the arrays of fluid distribution channels.

Aspects and embodiments of the invention are described in further detail below by way of example and with reference to the enclosed drawings in which:

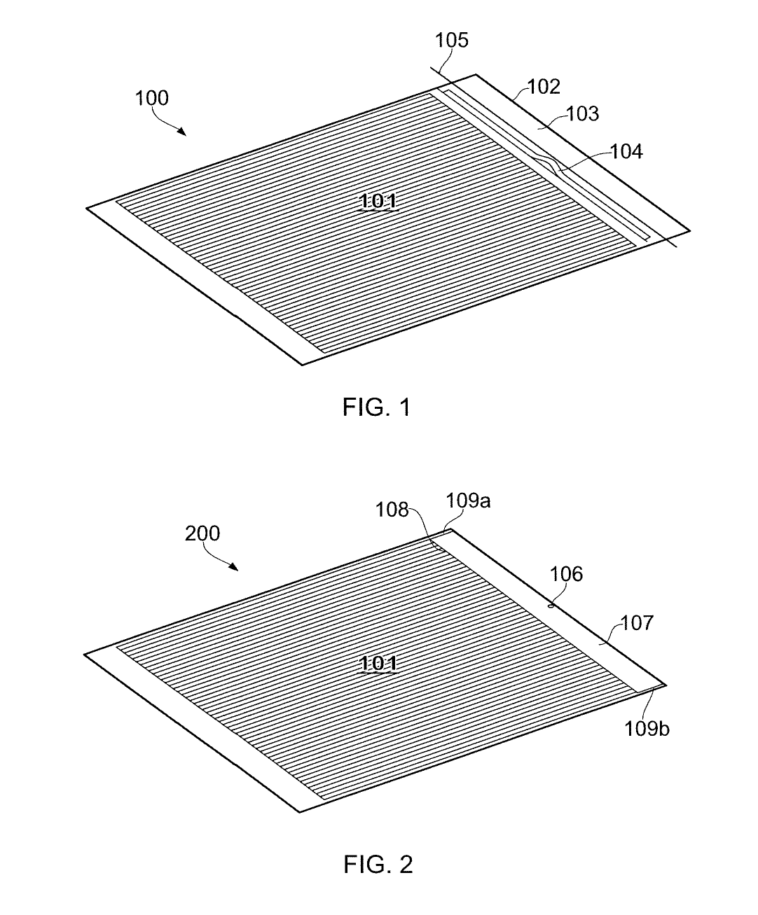

FIG. 1 is a perspective view of a bipolar fuel cell electrode plate with fluid feed distribution channels formed along an edge;

FIG. 2 is a perspective view of a bipolar fuel cell electrode plate similar to that in FIG. 1 after a folding operation;

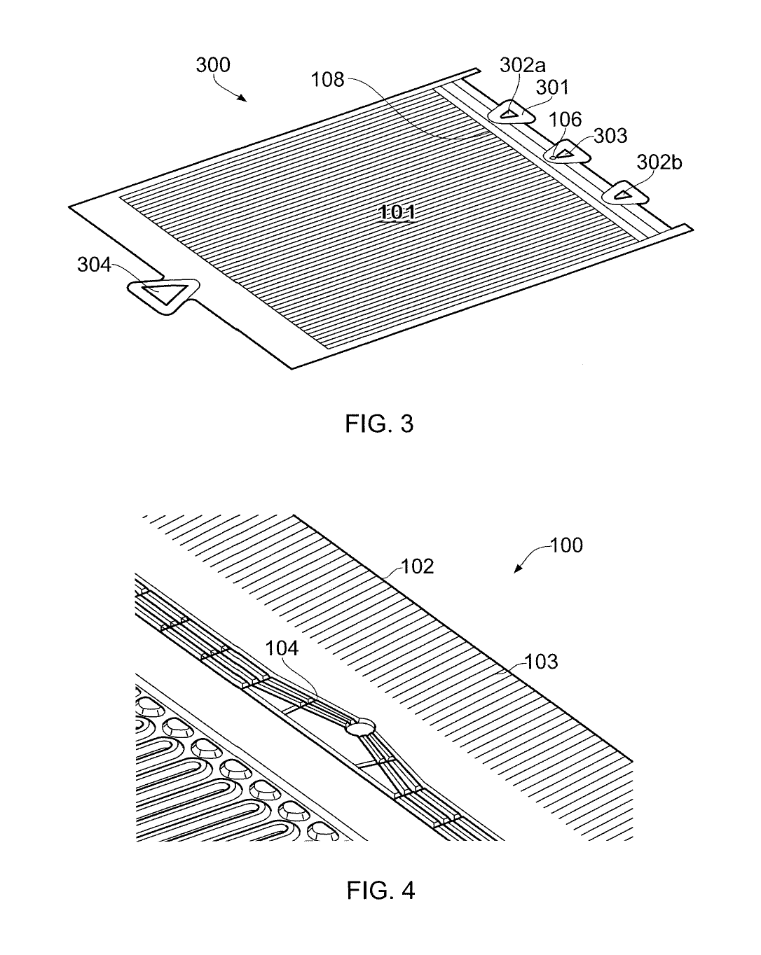

FIG. 3 is a perspective view of the bipolar fuel cell electrode plate of FIG. 2 after application of an over-moulded gasket around a periphery of the plate;

FIG. 4 is a partial perspective view of an edge of the plate in FIG. 1;

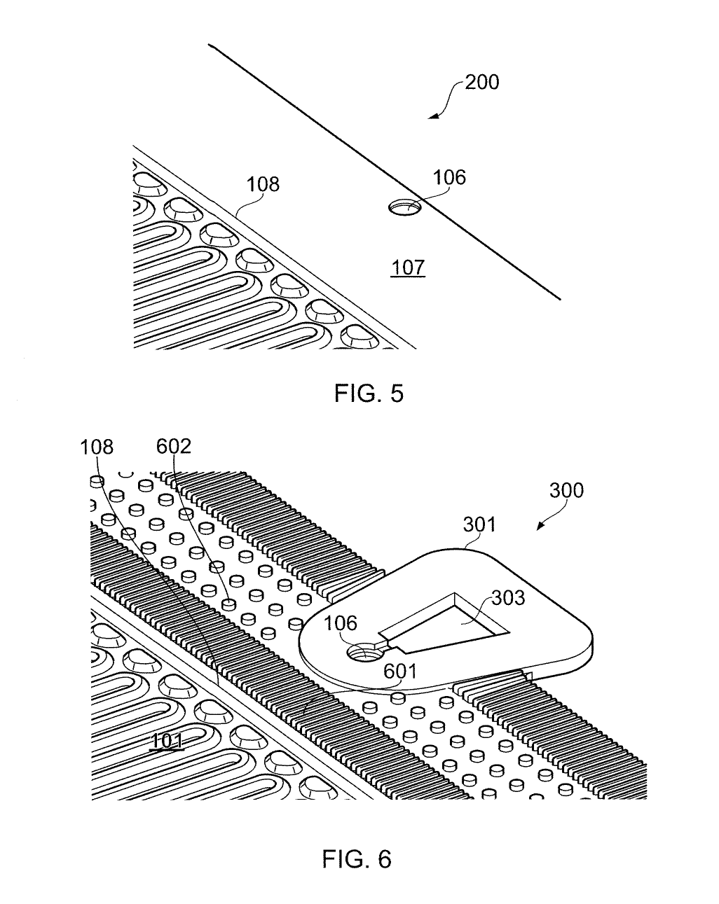

FIG. 5 is a partial perspective view of an edge of the plate of FIG. 2;

FIG. 6 is a partial perspective view of an edge of the plate of FIG. 3;

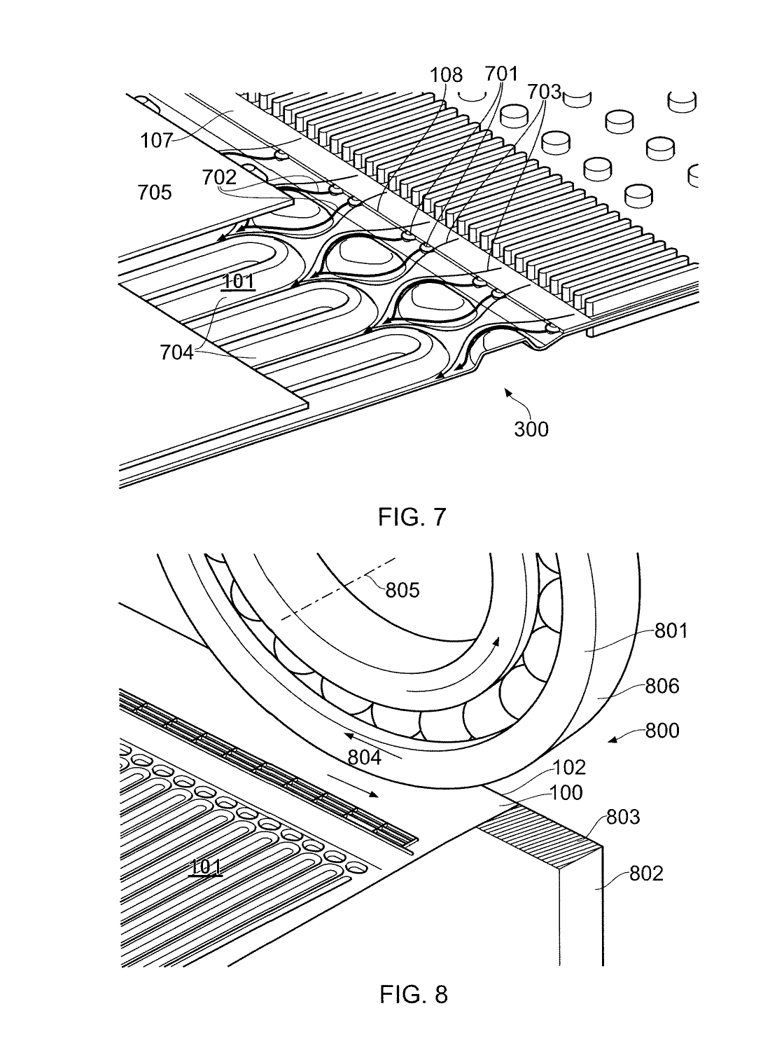

FIG. 7 is a partial perspective view of the edge of the plate in FIG. 6, illustrating fluid flow from the fluid feed distribution channels into a cathode fluid feed region; and

FIG. 8 is a partial perspective view of a machining operation for forming fluid feed distribution channels in a fuel cell plate.

Shown in FIG. 1 is an exemplary bipolar fuel cell plate 100 after operations to form a corrugated cathode fluid flow field region 101. Along a first edge 102 of the plate 100 is formed a first array of micro-channels 103 and a second array of larger fluid feed channels 104 extending across the width of the plate 100, the first array 103 extending to the edge 102 of the plate. Following these operations, the plate is folded along a fold line 105, resulting in the form of plate 200 illustrated in FIG. 2, in which the first and second arrays 103, 104 are enclosed within the folded region 107. A fluid entry port 106 is formed through the thickness of the plate 200, either before or after the folding operation, allowing access for coolant into the folded region 107 and along the now enclosed channels 103, 104. In use, coolant flowing into the folded region 107 through the port 106 is distributed across the width of the plate along the enclosed second array of channels 104 and transported along the first array of channels 103 towards the edge 108 of the folded region 107, which corresponds to the edge 102 of the unfolded plate 100.

FIG. 3 illustrates the bipolar plate 300 following a further operation to apply an over-moulded gasket 301 to the peripheral edge of the plate 300. The gasket 301 encapsulates the folded region 107 along opposing open edges 109a, 109b (FIG. 2), while leaving the long edge 108 of the folded region 107 open. The moulded gasket 301 also provides various surface features to allow a cathode air supply to be transmitted to the cathode flow field 101 via one or more air inlet ports 302a, 302b. The gasket 301 also forms a coolant entry port 303 connected to port 106 for access to the folded region 107. A cathode outlet port 304 is provided adjacent an opposing edge of the plate 300, in fluid communication with the cathode fluid flow field 101.

FIGS. 4 and 5 show more detailed views of an edge portion of the bipolar plate 100 before and after a folding operation to form the folded region 107. The first array of parallel micro-channels 103 is formed along the edge 102 of the plate 100. Also visible in FIG. 3 is the second array of larger channels 104 formed adjacent to the first array of micro-channels 103, the larger channels configured to distribute coolant from the port 106 across the width of the plate 100 within the folded region 107. The second array of fluid channels 104 are in the form of a grid of intersecting channels, a first set extending across the width of the plate and a second set transverse to, and interconnecting, the first set. The first set of channels serve to transport fluid from the central port 106 (FIG. 5) across the width of the plate 200, while the second set of channels stabilise the geometry of the plate, reducing any distortion during the folding process to form the folded region 107. The second set of channels also serve to transport coolant fluid to the front channel, i.e. the channel closest to the edge 108 (FIG. 5) from the other channels. Having multiple channels in the first set increases the cross sectional area of the channels for fluid flow across the plate while maintaining a geometry that resists collapse in subsequent processing and in assembly of the fuel cell stack. In the embodiments illustrated, all of the channels in the first set extend across the full width of the plate, so as to reduce distortion to the plate, although this feature is not essential to the invention, as the channels only need to transport fluid across the width of the cathode fluid flow region 101.

The first array of channels 103 are oriented in a direction across the surface of the plate 100 transverse to the direction of the channels in the second array 104. A piercing is formed in the plate 100 to form the port 106 either before or after the folding operation. In use, coolant flows into the folded region 107 through the port 106 and into the second array of channels 104 (FIG. 4). The coolant is distributed across the width of the plate along the folded region 107 by the second array of channels 104 and exits the folded region by travelling along the channels in the first array 103, leaving the folded region 107 along the edge 108 of the folded plate 200. By making the cross-sectional dimensions of the channels in the second array 104 larger than those of the first array 103, a larger pressure drop is created between the edge 108 of the folded region and the second array 104 compared to that across the width of the plate along the second array 104, ensuring a more uniform distribution of coolant out of the edge 108 of the folded region 107. The cross-sectional dimensions of the channels in the second array are preferably at least twice, and optionally at least three or four times those of the channels in the first array 103. For example, if the channels in the first array 103 have a depth or width of around 20 μm the comparable dimensions in the second array 104 may be at least 40 μm, 60 μm or 80 μm in depth or width. Due to the larger dimensions of the channels in the second array 104, conventional pressing or embossing techniques may be used to form the channels.

FIG. 6 show a detailed view of the edge of the bipolar plate after the gasket 301 is applied, which completes the bipolar plate construction. The view shown indicates the moulded water inlet port 303 and the piercing through the plate forming the port 106 for accessing the folded region. The gasket geometry also forms fluid flow paths for air flow across the plate 300 through to the cathode fluid flow field 101 in the form of castellations 601 and open areas comprising isolated projections 602.

A detailed schematic view of the folded region 107 of the plate 300 is shown in FIG. 7. A cutaway view of an overlying gas diffusion layer 705 is shown across the cathode fluid flow field 101. Water droplets 701 are shown forming at the edge 108 of the folded region 107, the droplets 701 forming at the ends of the micro-channels enclosed within the folded region 107. Once the water droplets 701 reach a size sufficient to break surface tension, they travel across the plate (arrows 702) in the direction of air flow along the plate 300 (arrows 703) and along the cathode fluid flow channels 704 in the plate. As the droplets travel along the fluid flow channels 704 heat is extracted from the plate 300 by evaporation of water in the droplets 701.

Controlling transport of cooling water droplets using surface tension compared to relying solely on the cathode air flow not only promotes accurate water distribution but also reduces the sensitivity of the fuel cell stack to orientation, vibration, shake and varying cathode flow rates.

FIG. 8 is a schematic diagram of a detailed view of an apparatus 800 for providing the first array of micro-channels on the cathode face of the plate 100. The apparatus 800 comprises a roller 801 and a die 802, a planar surface of the die 802 having an array of ridges 803. The ridges 803 are configured to form the first array of micro-channels along the edge 102 of the plate 100 as the roller 801 moves relative to the plate (arrows 804) while applying pressure through the thickness of the plate 100. The use of a rolling process against a planar die, rather than using a linear pressing or coining operation, allows for a greater degree of control of the uniformity of the channel geometry across the width of the plate 100 and allows the process to be carried out after a pressing operation to form the cathode fluid flow field 101 (the reverse side of which is shown in FIG. 8).

Typically each channel will have a cross section of approximately 20 microns wide and 15 microns in depth. The cross sectional area for each channel will generally need to be manufactured within a ±2% variation to achieve a satisfactorily uniform water distribution in operation. This is possible to achieve by using a rolling element while maintaining a constant force across the thickness of the plate.

The rotational axis 805 of the rolling element 801 may be orthogonal to the direction of travel 804 and parallel to the direction of channels formed on the plate 100. In alternative embodiments the channels may be oriented at an angle to the rotational axis 805, either by rotating the axis 805 relative to the die 802 or by aligning the ridges 803 in a direction away from orthogonal. The effect of this would be to progressively form each micro channel as the roller 801 is traversed relative to the die 802. If the roller axis 805 is aligned away from being orthogonal to the direction of traverse 804, the resultant slippage between the roller and the plate 100 may be accommodated by having the surface 806 of the roller 801 tapered.

The bipolar plate 100 is preferably made of steel, with an over-moulded elastomeric gasket 301. The gasket 301 may alternatively be made of a separate component laid on the plate during assembly of a fuel cell stack.

Other embodiments are intentionally within the scope of the invention as defined by the appended claims.

1. A method of forming fluid distribution channels in a fuel cell electrode plate, the method comprising traversing the plate between opposing surfaces of a roller and a planar die while applying pressure through the thickness of the plate to thereby form a series of channels across a surface of the plate.

2. The method of claim 1 wherein the surface of the planar die comprises a series of ridges configured to form the series of channels.

3. The method of claim 1 wherein the series of channels have cross-sectional dimensions of 25 μm or smaller.

4. The method of claim 3 wherein the series of channels have a depth or width in the range of 15 μm to 20 μm.

5. The method of claim 4 wherein a variation in the depth or width of the series of channels is within 5% of a mean value.

6. The method of claim 1 wherein a rotation axis of the roller is oriented at an angle of less than 90° to a direction the plate is passed between the roller and the die.

7. The method of claim 6 wherein the surface of the roller is tapered along the rotation axis.

8. The method of claim 1 wherein the series of channels comprises a parallel array of channels across the surface of the plate.

9. An apparatus for forming fluid distribution channels in a fuel cell electrode plate, comprising a roller and a planar die configured and arranged to form a series of channels in a plate traversed between surfaces of the roller and die under pressure.

10. The apparatus of claim 9 wherein the surface of the planar die comprises a series of ridges configured to form the series of channels in the plate.

11. The apparatus of claim 10 wherein the series of ridges are configured to form the series of channels having cross-sectional dimensions of 25 μm or smaller.

12. The apparatus of claim 10 wherein the ridges are configured to form the series of channels with a depth or width in the range of 15 μm to 20 μm.

13. The apparatus of claim 10 wherein the series of ridges comprise an array of parallel ridges across the surface of the planar die.

14. A fuel cell electrode plate comprising first and second arrays of channels formed in a surface thereof within a folded region of the plate, the first array of channels extending from an edge of the plate across a first internal face of the folded region, the second array of channels extending across a second opposing face of the folded region in a second direction transverse to the first direction.

15. The fuel cell electrode plate of claim 14 wherein the folded region comprises a port through the thickness of the plate and in fluid communication with the arrays of fluid distribution channels.

16. (canceled)

17. (canceled)

18. (canceled)

19. The method of claim 2 wherein the series of channels have cross-sectional dimensions of 25 μm or smaller.

20. The apparatus of claim 11 wherein the series of ridges comprise an array of parallel ridges across the surface of the planar die.

21. The apparatus of claim 12 wherein the series of ridges comprise an array of parallel ridges across the surface of the planar die.
